(19) United States
(12) Patent Application Publication
(10) Pub. No.: US 2014/0353403 A1
(43) Pub. Date: Dec. 4, 2014

(54) Adhesive Spray System for Hindering Intruders

(71) Applicant: Ofer Hai, Mitspe Adi (IL)

(72) Inventor: Ofer Hai, Mitspe Adi (IL)

(21) Appl. No.: 13/904,435

(22) Filed: May 29, 2013

(51) Int. Cl. G08B 15/00

(52) U.S. Cl. CPC G08B 15/007
USPC 239/289

(57) ABSTRACT

A system designed to hinder the movement of an intruder inside a structure by spraying an adhesive material on the floor where the intruder is located and/or in other places in the structure. The system is a stand-alone system that operates independently from other alarm systems installed in the structure and comprises a sensor, a container filled with adhesive, a spray mechanism with a sprayer, and a control unit

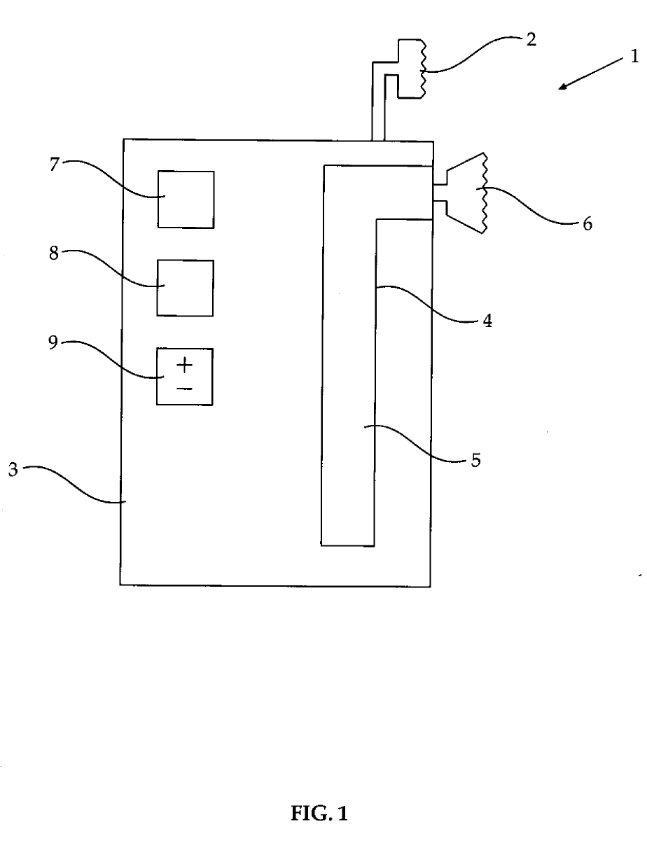

### TECHNICAL FIELD

The present invention refers to a system designed to spray adhesive so as to hinder intruders in the act of intruding into structures such as homes, offices, factories, and so on.

### BACKGROUND ART

The intrusion of intruders into structures in order to perform an act of theft is a known phenomenon and owners of structures (such as apartments, houses, offices, factories, and structures with other purposes) commonly install alarm systems designed to alert in the case of unauthorized intrusion into the structure. In many cases the alarm system does not effectively prevent theft from occurring, since professional and skilled thieves often succeed in collecting their loot, exiting the structure, and escaping by vehicle or on foot within several minutes after the alarm is activated but before security forces arrive at the scene. The system, subject of the present invention, can act either as a complimentary system to an existing alarm system or as a stand-alone system, although obviously it is recommended as a complimentary system to an alarm system.

### DESCRIPTION OF THE DRAWINGS

The intention of the drawings attached to the application is not to limit the scope of the invention and its application. The drawings are intended only to illustrate the invention and they constitute s only one of its many possible implementations.

Drawing No. 1 presents a schematic view of the system (1), which includes a sensor (2), a tank (3), a spray mechanism (5) with a sprayer (6), a control unit (7) with an internal timer (8), and a connection to a power source (9).

### THE INVENTION

The main objective of the present invention is to provide a system designed to hinder the movement of intruders when inside a structure by spraying an adhesive material on the floor where the intruder is located and/or on the intruder's legs and in other places the intruder is likely to try to reach, whether when fleeing the structure or when seeking artifacts of the kind an intruder would be interested in stealing.

The system (1), subject of the present invention, is an independent, stand-alone system that is not connected to any other alarm and/or protection systems installed in the structure. The system (1) comprises a sensor (2), a tank (3) filled with adhesive (4), a spraying mechanism (5) that includes a sprayer (6) and a control unit (7), which can also include an activation timer (8). The system is also equipped with an independent battery (9) that supplies power to the system and/or a connection to the electricity mains and a backup battery in case of power failure.

The general structure and operation of the system (1): The system (1) has several sensors (2), each one of which is designed to cover a specific section of the structure. Each individual sensor (2), or in other words, each individual section, has a designated tank (3) equipped with a spraying mechanism (5) with a sprayer (6) that covers the relevant section. When the system (1) is installed in a structure, the strategic sections that are to be covered are defined. These include entrances to rooms that house artifacts that are desirable to thieves, sections of corridors that may be used as escape routes from the structure or that lead to the valuable artifacts locations, entrances and exits from the structure, sections adjacent to windows, and so on. A sensor (2), designed to sense the presence of a person in the relevant section is then installed in each strategic section and is directed towards the section. A container (3) and a spraying mechanism (5) and sprayer (6) are assigned to the relevant section and coupled with the sensor. When the sensor (2) detects the presence of a person in the relevant section, the control unit activates the spraying mechanism (5) which causes the sprayer (6) to spray the adhesive (4) from the corresponding tank (3) onto the floor of the relevant section and at lower leg height.

The tank (3), spraying mechanism (5) and sprayer (6) should be installed at a height between 10 cm and 50 cm from the floor, although higher and lower heights are possible as well. The adhesive (4) is sprayed onto the section floor and lower legs of the intruder in a way that prevents the intruder from moving about efficiently and easily, thus interfering with the theft and escape, and in some cases, the intruder might even actually stick to the floor. The control unit (7) enables the structure owner to determine whether, when a specific sensor (2) is activated, other spraying mechanisms (5) will be activated in other defined sections which the intruder will likely try to reach, either during his or her escape or with the intention of reaching valuable artifacts. Such multiple activation of different sprayers will cause the intruder to be hindered repeatedly.

The sensor (2) can be any kind of sensor that is currently known or that will be known in the future, such as volume sensors, infrared sensors, heat detectors, and so on. The sensor (2) is designed to identify the presence of a person in the section towards which it is directed and therefore the sensor (2) should be directed towards a relatively small section of the structure.

The tank (3) can be any kind of container designed to contain adhesive material and attached to an automatic spraying mechanism. There is no need to provide elaborate explanations regarding such containers, since they are common knowledge for any average expert in the field. The tank (3) is filled with one of a variety of available adhesives (4) which can be sprayed from a container.

The spraying mechanism (5) can be any known mechanism that activates a system automatically upon receiving a signal [for instance, from the control unit (7) after it receives a signal from the sensor (2)]. In such as case, the spraying mechanism (5) is activated immediately and causes the sprayer (6) to spray the adhesive material (4) contained in the tank (3).

Each sensor (2) may be equipped with a separate timer (8) or, alternatively, the control unit (7) may include a timer. The objective of the timer (8) is, among other things, to prevent the system (1) from being activated during the structure's hours of regular activity, assuming that during these hours, any activation would be the result of a system failure or human error.

The system (1) is equipped with connection to a power source (9), which may either be a direct connection to the electricity mains with a backup battery or an independent battery that prevents a situation whereby a power failure in the structure compromises the system (1).

Disposable spray unit: The system (1) can and should be a stand-alone and easy-to-install system whereby each sensor (2) is paired with a tank (3) that is equipped with its own spraying mechanism (5), sprayer (6), control unit (7), activation timer (8), and power supply (9). Thus, the structure owner can purchase a system (1) that is composed of several pairs of units: the sensor unit (2) and an additional disposable unit that includes a tank, a spraying mechanism, a sprayer, a control unit, a timer, and a connection to a power source (hereinafter referred to collectively as a “spray unit”). The structure owner may self-install the system (1) in a simple and efficient manner and if a spray unit is activated, the structure owner can simple remove it and install a new spray unit in its place. Furthermore, the entire system (1) can be one single disposable unit.

is The adhesive material (4) ejected from the tank (3) may be a sticky foam of one component or two components wherein each component in separate tank with one tube and mixing element just when foam is being ejected to the burglar. So, it is possible and desirable that the system (1) may includes two tanks (3) wherein each of them includes polyurethane wherein the mixing of the materials make it sticky. The polyurethane can be made in a variety of densities and hardnesses by varying isocyanate, polyol or additives.

What is claimed is:

1. A system designed to hinder the movement of an intruder inside a structure by spraying an adhesive material where the intruder is located and/or in other places in the structure wherein the said system is a stand-alone system that operates independently from other alarm systems installed in the structure and comprises: a sensor, one or two tanks filled with adhesive materials, a spray mechanism with a sprayer, and a control unit.

2. The system mentioned in claim No. 1 wherein it comprises two units: a sensor unit that includes the sensor and a spray unit that includes one or two tanks, a spray mechanism with a sprayer, and a control unit.

3. The system mentioned in claim No. 2 wherein the spray unit is disposable.

4. The system mentioned in claim No. 1 wherein it comprises a single unit that includes a sensor, one or two tanks, a spraying mechanism with a sprayer, and control unit.

5. A system designed to hinder the movement of an intruder inside a structure by spraying an adhesive material where the intruder is located and/or in other places in the structure comprises: a sensor, one or two tanks filled with adhesive materials, a spray mechanism with a sprayer, and a control unit.
